(19) United States
(12) Patent Application Publication
(10) Pub. No.: US 2015/0154564 A1
(43) Pub. Date: Jun. 4, 2015

(54) WEIGHTED EVALUATION COMPARISON

(71) Applicant: HireVue, Inc., South Jordan, UT (US)

(72) Inventors: Nathan Moon, Sandy, UT (US); Mark Newman, Orem, UT (US); Ryan Jameson, Gilbert, UT (US); Loren Larsen, Lindon, UT (US)

(21) Appl. No.: 14/548,048

(22) Filed: Nov. 19, 2014

Related U.S. Application Data
(60) Provisional application No. 61/910,758, filed on Dec. 2, 2013.

(51) Int. Cl. G06Q 10/10

(52) U.S. Cl. CPC G06Q 10/1053

(57) ABSTRACT

A method for facilitating the evaluation of candidates in an evaluation process is provided. The method includes operations of receiving a set of evaluation data from a candidate evaluation system, the set of evaluation data including at least evaluation ratings data and evaluation recommendation data for a set of candidate. The method further includes providing a user interface to a decision maker to display a performance of each of a set of candidates in a two-dimensional graphic representation. The method further includes receiving a first weighting for a first subset of the evaluation data and updating the graphic representation to show a weighted performance of each of the candidates in the evaluation. The updating is based on the first weighting received from the decision maker.

### RELATED APPLICATIONS

This application claims the benefit of U.S. Provisional Application No. 61/910,758 filed Dec. 2, 2013, and entitled “Weighted Evaluation Comparison,” the entire contents of which are incorporated herein by reference.

### BACKGROUND

Finding and hiring employees is a task that impacts most modern businesses. It is important for an employer to find employees that “fit” open positions. The processes associated with finding employees that fit well can be expensive and time consuming for an employer. Such processes can include evaluating numerous resumes and cover letters, telephone interviews with candidates, in-person interviews with candidates, drug testing, skill testing, sending rejection letters, offer negotiation, training new employees, etc. A single employee candidate can be very costly in terms of man-hours needed to evaluate and interact with the candidate before the candidate is hired.

Computers and computing systems can be used to automate some of these activities. For example, many businesses now have on-line recruiting tools that facilitate job postings, resume submissions, preliminary evaluations, etc. Additionally, some computing systems include functionality for allowing candidates to participate in “virtual” on-line interviews.

The job of interviewers and candidate reviewers is to determine if candidates are skilled and have the qualifications required for a particular job. In the process of doing this, they compare and contrast the qualifications of candidates—often reviewing and comparing candidate responses to particular questions or tasks. While computing tools have automated interview response gathering, there is still a lot of effort spent in evaluating the numerous responses that may be submitted in large quantities of applications for a single opening. Often, the ratings and recommendations of multiple candidate reviewers are provided to and used by a single decision maker in making a final decision from among the candidates.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a block diagram of a system architecture in which embodiments of an evaluation review tool may operate according to one embodiment.

FIG. 2 is a block diagram of evaluation review tool according to one embodiment.

FIG. 3 is a flow diagram of a method of generating visualizations for a decision maker from a set of evaluation data according to one embodiment.

FIG. 4A is an exemplary graphical user interface for using a set of evaluation data according to one embodiment.

FIG. 4B is another view of the exemplary graphical user interface of FIG. 4A for using a set of evaluation data according to another embodiment.

FIG. 4C is another view of the exemplary graphical user interface of FIG. 4A for using a set of evaluation data according to another embodiment.

FIG. 4D is another view of the exemplary graphical user interface of FIG. 4A for using a set of evaluation data according to another embodiment.

FIG. 5 illustrates a diagrammatic representation of a machine in the exemplary form of a computing system for evaluation review according to an embodiment.

Some aspects of these figures may be better understood by reference to the following Detailed Description.

### DETAILED DESCRIPTION

Methods and systems for evaluation review that improve the reviewing of digital interviews and other digitally-captured evaluation processes are described herein. In the following description, numerous details are set forth. In one embodiment, an evaluation review tool selects and/or receives a data set of evaluation data. In one example, the data set of evaluation data may include digital response data, assessment data, or both. In one embodiment, the digital response data can include responses of a candidate to a series of prompts. In another embodiment, the evaluation data can also include assessment data including: rating information, such as a rating of responses of a candidate to a series of prompts or ratings of performances to various tests or assignments; assessment results; recommendations regarding the candidate, such as hiring or selection recommendations; hiring or selection decisions, as so forth. In one example, the series of prompts, tests, and/or assignments can be administered as part of the evaluation process. In another example, the evaluation data may include multiple evaluations of multiple candidates collected during an evaluation campaign. The evaluation review tool analyzes the evaluation data and provides a user interface, such as graphical user interface, to permit a decision maker, e.g., a hiring or admissions manager. The user interface can enable the decision maker to visualize the evaluation data to make a final decision regarding one or more candidates. The evaluation review tool can provide the user interface using instructions for the user interface. In one embodiment, the evaluation data can be displayed in a two-dimensional graphic representation. In one embodiment, the two-dimensional graphic representation can be a two-dimensional plot, a two-dimensional chart, a two-dimensional diagram, and so forth. In another embodiment, the evaluation data can be displayed in other formats, display configurations, and/or other arrangements, such as one-dimensional or three-dimensional graphic representations.

The evaluation review tool may also receive input from a decision maker that modifies the evaluation data or the presentation of the evaluation data in the two-dimensional graphic representation. The decision maker (also referred to herein as a decision maker) may assign different weights to different evaluators. In one embodiment, the decision maker may input a high weighting for an individual whom the decision maker places a relatively high level of trust. In another embodiment, the decision maker may input a lower weight for an individual whom the decision maker places a relatively low level of trust. For instance, the decision maker may input a higher weight for a supervisor's evaluation data than to an evaluation provided by a peer (i.e., a potential peer) of the candidate undergoing the evaluation. In another embodiment, the decision maker may alter the weighting of a particular subset of evaluation data, such as the ratings for candidates' responses to a particular prompt or to a particular evaluation task. In some embodiments, the weightings may be received by the evaluation review tool prior to the presentation of the evaluation data in the two-dimensional graphic representation. In yet other embodiments, the weightings may be received before the evaluation data has been collected during an evaluation campaign. In another embodiment, the weightings may be received while the decision maker is evaluating the two-dimensional graphic representation and an initial presentation of the two-dimensional graphic representation can be updated based on weightings and any changes to the weightings.

When the weightings are collected before a two-dimensional graphic representation is provided to the decision maker in a user interface, the evaluation data is updated using the weightings prior to display in the two-dimensional graphic representation to the decision maker. When weightings are received by the evaluation review tool after an initial presentation of the two-dimensional graphic representation, the two-dimensional graphic representation is subsequently updated to reflect the weighting or weights received from the decision maker.

Embodiments of the present disclosure may enable a decision maker to more easily use information that has been accumulated for multiple candidates from multiple evaluators. The embodiments described herein may present multiple aspects of a candidate performance simultaneously or concurrently to the decision maker in a single user interface. The decision maker is further enabled to assign and adjust weightings for specific aspects of the evaluation data to improve the data quality, which may enable better decisions in filling an open position or opportunity, and in some cases the best decisions possible.

In some instances in this description, well-known structures and devices are shown in block diagram form, rather than in detail, in order to avoid obscuring the embodiments of the present disclosure. It will be apparent, however, to one of ordinary skill in the art having the benefit of this disclosure, that embodiments of the present disclosure may be practiced without these specific details.

With the ability to recruit for positions nationally and even internationally using the Internet, the number of qualified candidates applying for a given job can be expensive and time consuming to evaluate. For more technical positions, subject-matter experts are used for evaluation and screening of candidates rather than focusing on regular job duties. With the adoption of digital video interviewing, the time needed to evaluate candidates is reduced, however, the problem of having too many candidates to filter through still remains.

Digital interviews or other evaluations, such as a pitch for investment funding or a grant, an admissions interview, job performance evaluations, or other presentation meriting assessment and comparison may include responding to a series of prompts or questions. The responses to those prompts by a person or group being evaluated can be captured as digital data and later reviewed and rated by an evaluator. Additionally, test or other forms of response may be included in a digital evaluation. For example, a small coding assignment may be included as part of the digital evaluation when a targeted campaign is intended to find the developer. Other written input, such as an essay or writing sample, may be uploaded or otherwise provided for use in an evaluation.

Because there may be many candidates, a large data set is collected that includes the recorded responses and other responses for each candidate. When evaluators later view the recorded responses or other inputs, the evaluators may assign ratings for each response or input. In some embodiments, such as where a sample of code or other work product is assessed, the rating or scoring may be performed by a rating machine or program. Multiple ratings or scores may be generated for such responses. This evaluation data may be input and collected for presentation to a decision maker who is responsible for reviewing the evaluations performed by the evaluators and for making a final decision as to accepting one or more candidates. Embodiments of the present disclosure enable effective presentation of such evaluation data to decision makers.

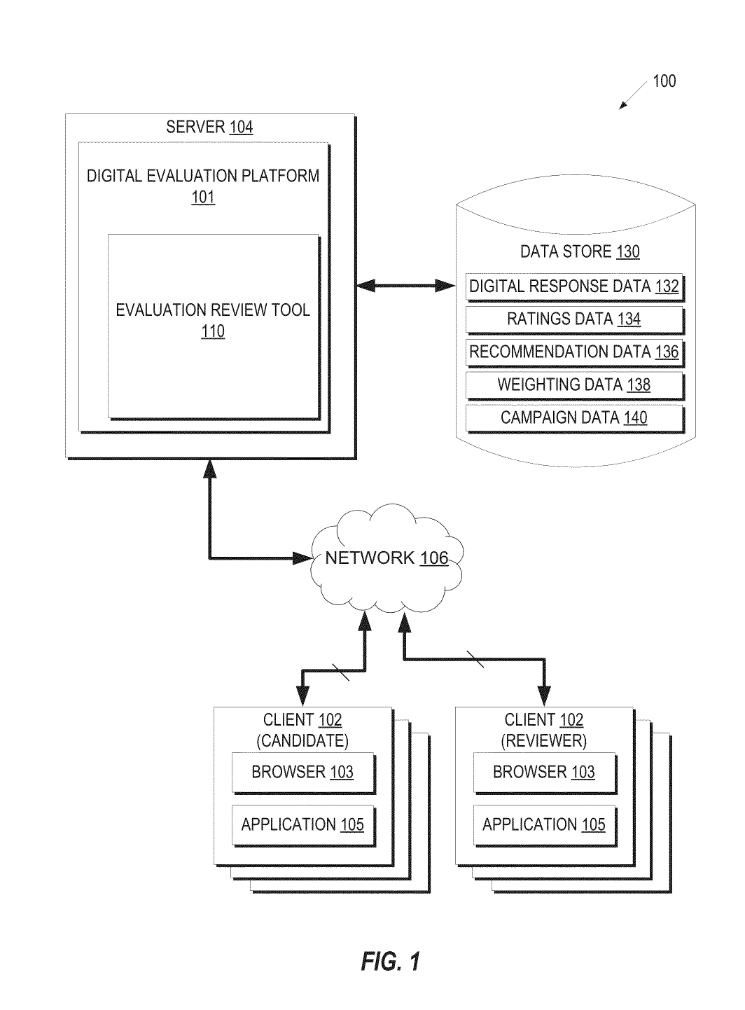

FIG. 1 is a block diagram of a system architecture 100 in which embodiments of an evaluation review tool 110 may operate. The system architecture 100 may include multiple client computing systems 102 coupled to a server computing system 104 (also referred to herein as server 104) via a network 106 (e.g., a public network such as the Internet, a private network such as a local area network (LAN), or a combination thereof). The network 106 may include the Internet and network connections to the Internet. Alternatively, the server 104 and the client 102 may be located on a common LAN, personal area network (PAN), campus area network (CAN), metropolitan area network (MAN), wide area network (WAN), wireless local area network, cellular network, virtual local area network, or the like. The server computing system 104 may include one or more machines (e.g., one or more server computer systems, routers, gateways) that have processing and storage capabilities to provide the functionality described herein. The server computing system 104 may provide or support a digital evaluation platform 101, which in turn may provide the evaluation review tool 110. The evaluation review tool 110 can perform various functions as described herein and may include multiple components to access and process data and to provide a user interface so that a decision maker can request access to and request modifications to the evaluation data.

The evaluation review tool 110 can be implemented as a part of the digital evaluation platform 101, such as the digital interviewing and evaluating platform developed by HireVue, Inc. of South Jordan, Utah, or may be implemented in another digital evaluation platform such as an investment evaluation platform or an admission evaluation platform. While many of the examples provided herein are directed to an employment/hiring context, the principles and features disclosed herein may be equally applied to other contexts and so such are within the scope of this disclosure as well. For example, the principles and features provided herein may be applied to a job performance evaluation, an evaluation of a sales pitch, an evaluation of an investment pitch, probation decisions, etc.

The evaluation review tool 110 can be implemented as a standalone system that interfaces with the digital evaluation platform 101 or other systems. It should also be noted that in the embodiment illustrated in FIG. 1, the server computing system 104 implements the evaluation review tool 110, but one or more of the clients may also include client modules of the evaluation review tool 110 that can work in connection with, or independently from the functionality of the evaluation review tool 110 as depicted on the server computing system 104.

The client computing systems 102 (also referred to herein as “clients 102”) may each be a client workstation, a server, a computer, a portable electronic device, an entertainment system configured to communicate over a network, such as a set-top box, a digital receiver, a digital television, a mobile phone, a smart phone, a tablet, or other electronic devices. For example, portable electronic devices may include, but are not limited to, cellular phones, portable gaming systems, wearable computing devices or the like. The client 102 may have access to the Internet via a firewall, a router or other packet switching devices. The clients 102 may connect to the server 104 through one or more intervening devices, such as routers, gateways, or other devices. The clients 102 are variously configured with different functionality and may include a browser 103 and one or more applications 105. The clients 102 may include a microphone and a video camera to recorded responses as digital data. For example, the clients 102 may record and store video responses and/or stream or upload the recorded responses and other response data to the server 104 for capture and storage. In one embodiment, the clients 102 access the digital evaluation platform 101 via the browser 103 to record responses. The recorded responses may include audio, video, digital data, such as code or text, or combinations thereof. In such embodiments, the digital evaluation platform 101 is a web-based application or a cloud computing system that presents user interfaces to the client 102 via the browser 103.

Similarly, one of the applications 105 can be used to access the digital evaluation platform 101 in some embodiments. For example, a mobile application (referred to as an “app”) can be used to access one or more user interfaces of the digital evaluation platform 101. The digital evaluation platform 101 can be one or more software products that facilitate the digital evaluation process. For example, in some cases, the client 102 is used by a candidate (or interviewee) to participate in a digital interview. The digital evaluation platform 101 can capture digital response data 132 from the candidate and store the data in a data store 130. The digital response data 132 may include data uploaded by the candidate, audio captured during the interview, video captured during the interview, data submitted by the candidate before or after the interview, or the like. As illustrated herein, the digital response data 132 includes at least recorded responses in the form of videos captured during the interview process. Alternatively, the digital response data 132 does not include responses in the form of video captured during the interview, but may include data in other forms, such audio responses, textual responses, candidate submitted data, or the like.

The clients 102 can also be used by a reviewer or evaluator to review, screen, and select candidates and their associated response data and by a decision maker to review the ratings and recommendations, etc., of the evaluators. Evaluators and decision makers can access the digital evaluation platform 101 via the browser 103 or the application 105 as described above. User interfaces presented to the reviewer by the digital evaluation platform 101 are different than the user interfaces presented to the candidates. Similarly, user interfaces presented to the decision maker may be different than those presented to either the reviewers or candidates. The user interfaces presented to the reviewer permit the reviewer to access the digital response data 132 for reviewing and rating the responses and other input data of the candidates and entering recommendations. The ratings and recommendations may form a set of evaluation data. The user interfaces presented to the decision maker permit the decision maker to visualize the set of evaluation data and carefully modify the weightings of that data in order to reach a final decision.

The data store 130 can represent one or more data repositories on one or more memory devices. The data store 130 may be a database or any other organized collection of data. The data store 130 may store the digital response data 132, evaluation ratings data 134, evaluation result or recommendation data 136. The ratings data 134 and recommendation data 136 may form a set of evaluation data. The data store may also store weighting data 138, which indicates weightings to be assigned to the evaluation data. The weightings may be stored as variables to be applied to subsets of the evaluation data when the evaluation data is to be presented in a user interface to a decision maker.

In one embodiment, the subsets of the evaluation data can include subsets of data of ratings by evaluators for different prompts or tasks performed by candidates. In one example, a first subset of data can be rating data from an evaluator for responses of candidates to a first prompt. In another example, a second subset of data can be rating data from the evaluator for responses of candidates to a second prompt. In another example, a third subset data can be coding scores from the evaluator for performance of candidates on a coding task. In another embodiment, the subsets of the evaluation data can include subsets of data by different evaluators for ratings of prompts or tasks. In one example, a fourth subset of data can be rating data provided by a first evaluator for a prompt or task. In another example, a fifth subset of data can be rating data provided by a second evaluator for the same prompt or task that the first evaluator rated.

In one embodiment, each data subset can be non-overlapping data subsets of the evaluation data. In another embodiment, data included in one subset of the evaluation data can overlap with data included in a second subset of the evaluation data. In one example, a first weighting can be applied to a first subset of the evaluation data and a second weighting can be applied to a second subset of the evaluation data. When a portion of the evaluation data overlaps between the first subset and the second subset, the first weighting and the second weighting may be applied to the overlapping portion of evaluation data.

In some embodiments, the weighting data 138 may include the evaluation data after application of the weightings. Data store 130 may also store campaign data 140, which may include the prompts, assignments, and tasks, etc., used to conduct a digital interview. The campaign data 140 may also include information describing the position or opportunity for which one or more candidates are to be selected.

In the depicted embodiment, the server computing system 104 may execute the digital evaluation platform 101, including the evaluation review tool 110 for presenting evaluation data, receiving weightings information, and presenting updated evaluation data. The server 104 can include web server functionality that facilitates communication between the clients 102 and the digital evaluation platform 101 to conduct digital interviews or review digital interviews for purposes of evaluation as described herein, and to review the evaluations in order to arrive at a final decision.

Alternatively, the web server functionality may be implemented on a machine other than the machine running the evaluation review tool 110. It should also be noted that the functionality of the digital evaluation platform 101 for recording the digital response data 132 can be implemented on one or more servers 104 and the functionality of the digital evaluation platform 101 can be implemented by one or more different servers 104. In other embodiments, the system architecture 100 may include other devices, such as directory servers, website servers, statistic servers, devices of a network infrastructure operator (e.g., an ISP), or the like. Alternatively, other configurations are possible as would be appreciated by one of ordinary skill in the art having the benefit of this disclosure.

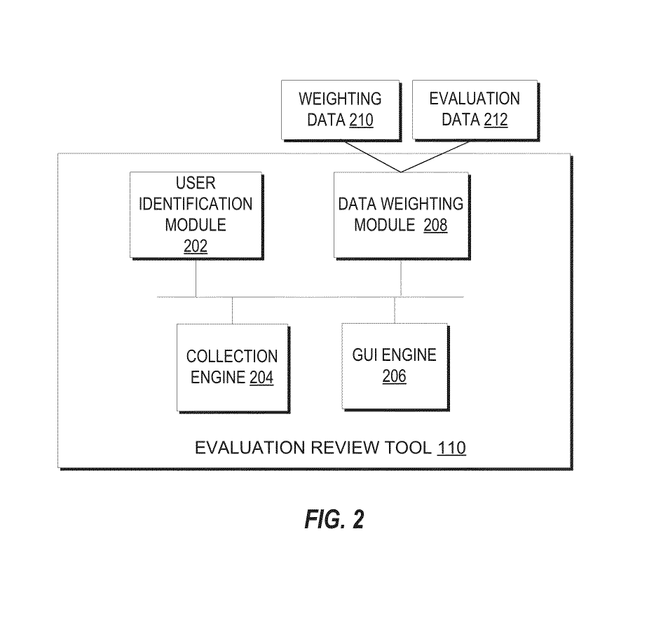

FIG. 2 is a block diagram of an evaluation review tool 110 according to one embodiment. The evaluation review tool 110 can be implemented as processing logic comprising hardware (circuitry, dedicated logic, etc.), software (such as is run on a general purpose computing system or a dedicated machine), firmware (embedded software), or any combination thereof. In the depicted embodiment, the evaluation review tool 110 includes a user identification module 202, a collection engine 204, a graphical user interface (GUI) engine 206, and a data weighting module 208. The components of the evaluation review tool 110 may represent modules that can be combined together or separated into further modules, according to some embodiments.

The user identification module 202 may be used to identify users of the digital evaluation platform 101 and to ensure that users may only access data they are authorized to access. To do this, the user identification module 202 may include or have access to a multiple profiles for each decision maker that accesses the evaluation review tool 110. For example, a decision maker may access the digital evaluation platform 101 and be prompted to enter credentials that, when verified, permit the decision maker to access multiple campaigns. For example, the decision maker may be a hiring manager at an information technology (IT) firm that is seeking to fill positions in IT administration, sales, and human resources. The user identification module 202 may identify the decision maker to the digital evaluation platform 101. Certain weightings may be stored by the evaluation review tool 110 in connection with an identifier of the decision maker, such that the weightings entered by the decision maker can be applied to another, similar, campaign at another point in time.

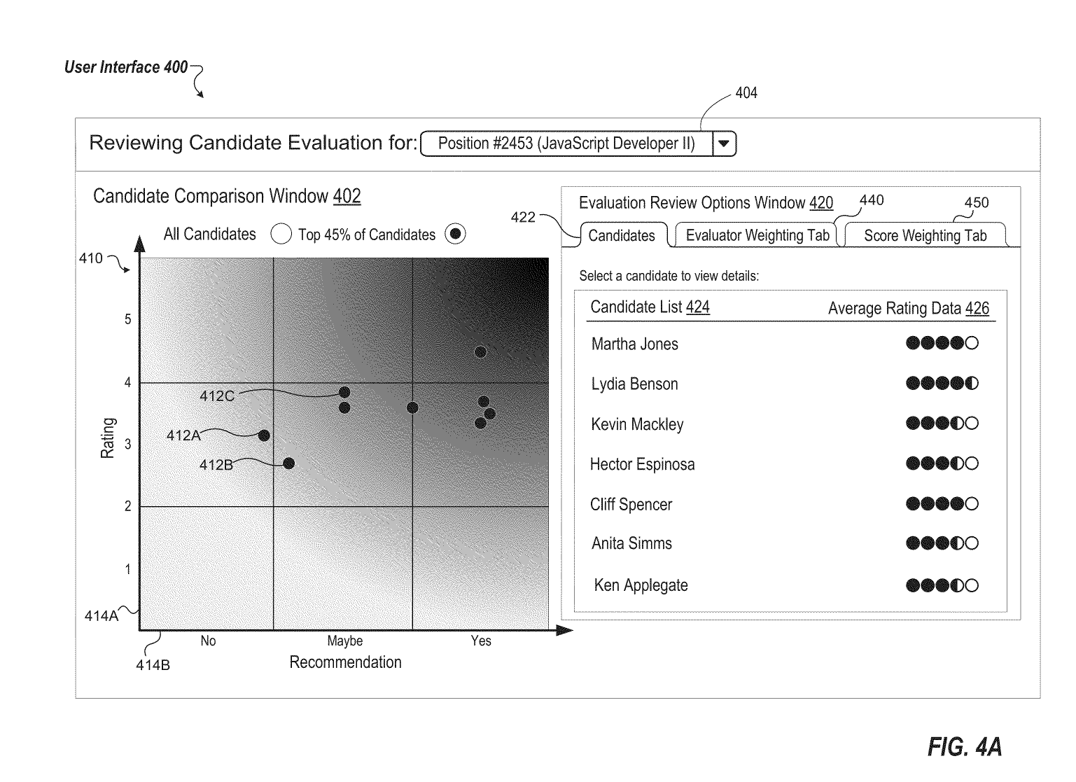

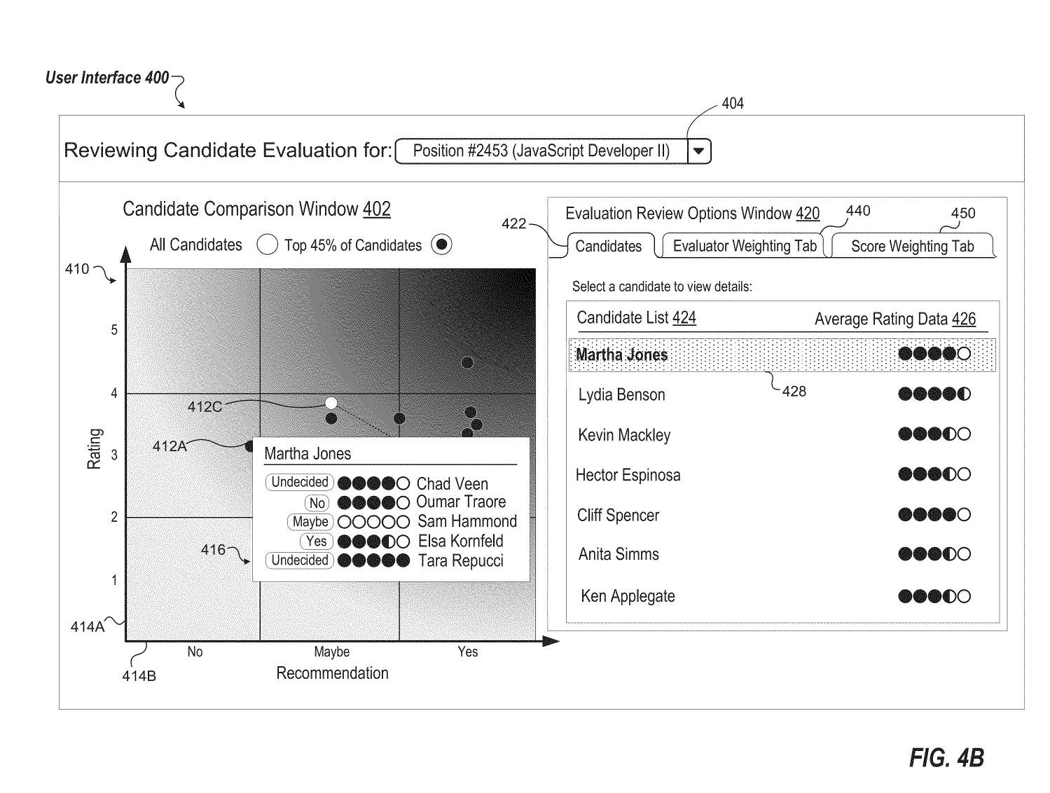

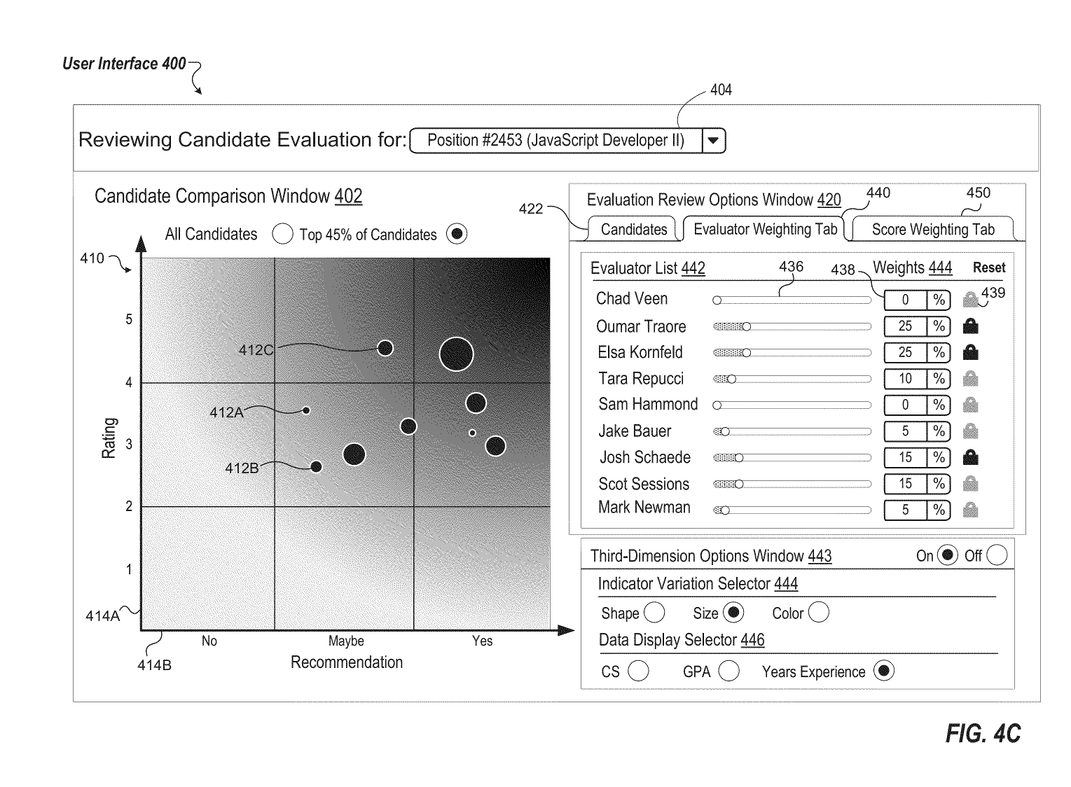

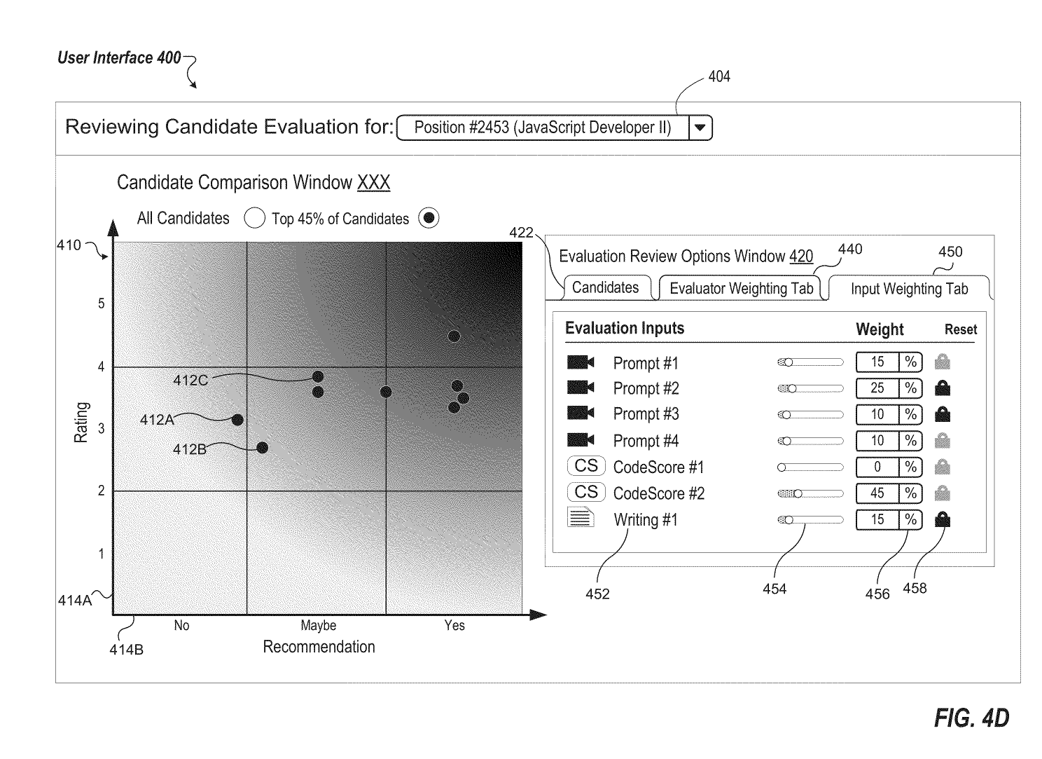

The collection engine 204 may communicate with processors and data stores over communication channels to retrieve data for use by the evaluation review tool 110. For example, when a decision maker requests to perform a review of candidates in a specific campaign, the decision maker may select the campaign using a user interface element. Upon selection of the campaign, the collection engine 204 may retrieve associated evaluation data 212. For example, the collection engine 204 may communicate with the data store 130 of FIG. 1 to retrieve ratings data 134 and recommendation data 136 associated with the campaign. After gathering the appropriate evaluation information, the GUI engine 206 may provide one or more user interfaces to display information to the decision maker and to receive information from the decision maker. In providing the one or more user interfaces, the GUI engine 206 may generate instructions that when rendered by the one of the clients 102 (whether by the browser 103 or by the application 105) present information in an interactive visual format to the decision maker. User interfaces generated and enabled by the GUI engine 206 may include several windows or frames, which may communicate information to the decision maker and permit the decision maker to enter information, such as weightings, and make requests. To communicate information to the decision maker, the user interface may include elements such as plots, charts, text fields, etc. To permit the decision maker to provide information and requests to the evaluation review tool 110, the user interfaces generated by the GUI engine 206 may provide buttons, drop-down selection elements, slider elements, text entry fields, etc. Examples of user interfaces that may be provided by the GUI engine 206 to communicate information to, and receive information from, a decision maker are discussed elsewhere herein with respect to FIGS. 4A, 4B, 4C, and 4D.

The data weighting module 208 may receive input for one or more weightings through the user interface provided by the GUI engine 206 or from pre-existing weighting data 210 stored and received from storage or memory. Each weighting may be applied to a specific type or subset of the evaluation data. For example, a decision maker may use a weighting to weight more heavily (or lightly) the portion of the evaluation data generated by a particular evaluator. For example, when the decision maker is selecting a new software engineer, the decision maker may decide to weight the ratings and recommendation of an engineering manager or managers more heavily than the ratings and recommendation of a sales manager or mangers. The decision maker may decide to weight a more experienced engineering manager's ratings and recommendations more heavily than a less experienced engineering manager's. In other instances, the decision maker may input a weighting that gives greater emphasis to a coding evaluation than to recorded video responses to prompts. More information is provided herein with respect to the ways in which the weightings may be received and applied. The data weighting module 208 may store weightings received from the decision maker through a user interface as the weighting data 210. Additionally, the data weighting module 208 may apply the various weightings received from the decision maker to the evaluation data 212 to arrive at updated, weighted evaluation data, which may then be displayed to the user by the GUI engine 206. The evaluation data and/or the updated weighted evaluation data may be presented to the decision maker in a two-dimensional graphic representation, such as a two-dimensional plot. Embodiments of the two-dimensional plot are illustrated in FIGS. 4A, 4B, 4C, and 4D, as is discussed further below.

In some embodiments, the weighting data 210 may be retrieved for use from storage or memory when the decision maker is identified by the user identification module 202. For example, a decision maker from a given company may be required by the company to use a specific set of weightings. In such cases, the GUI engine 206 may not provide elements to the decision maker for the entry of weightings.

In some embodiments, the evaluation data 212 (or the weighted evaluation data) is presented in a two-dimensional plot in which one axis is associated with an evaluation recommendation or result, such as “no,” “maybe,” “yes” or numerical values that can be mapped to such verbal categories. The other axis may be associated with the ratings received for candidates on a particular prompt or an average rating of each candidate, such that each candidate's performance may be visually depicted in the two-dimensional plot.

The evaluation data 212 and the weighting data 210 may be used by the data weighting module 208 in many different ways to provided weighted performance information the decision makers. The following represents calculations performed by the data weighting module 208 to generate a two-dimensional plot with weighted performance values according to one of the many different embodiments. Such calculations may be performed when requested by the decision maker, such as by entry of weightings by the decision maker, or upon initiating an evaluation review session in the digital evaluation platform 101. Supposing each candidate submitted N responses and/or pieces of work product to prompts as required by the prompts and tasks of the evaluation campaign, and there are M evaluators, each evaluator makes N ratings Rt_{n,m}, such that:

$${Rt}_{m} = {\sum }_{n = 1}^{N} \frac{{Rt}_{n , m}}{N} \qquad ( 1 )$$

where Rtₘ is the average of all the rating received by a candidate from one of the M evaluators. Additionally, each candidate may receive as many recommendation values Rcₘ as there are evaluators that provide a recommendation to the digital evaluation platform 101.

Each candidate's performance may be mapped to the two-dimensional plot in which the position along one axis is determined by Equation (2) as seen below:

$${\sum }_{m = 1}^{M} \frac{{Rt}_{m}}{M} \qquad ( 2 )$$

which indicates a candidate's average rating. And the candidate performance is further indicated along the other axis of the two-dimensional plot by Equation (3) as seen below:

$${\sum }_{m = 1}^{M} \frac{{Rc}_{m}}{M} \qquad ( 3 )$$

which indicates the candidate average recommendation value.

In some embodiments, the data weighting module 208 of the evaluation review tool 110 may normalize these values such that each rating is a value between 0 and 1 and each recommendation is a value between 0 and 1. The position of a candidate may be determined from the normalized ratings and recommendations.

Provided by the GUI engine 206, a user interface permits the decision maker to modify weightings. For example, by default, the rating of each prompt could be equal and the ratings from each evaluator could also be equal. The decision maker may also modify the weights for a particular prompt. The evaluation review tool 110 may normalize the weightings such that the weightings sum up to 1. Thus for each set of prompts Σₙ₌₁^{N}Wₙ=1, and for each evaluator Σₘ₌₁^{M}Wₘ=1. For example, if there are five prompts [A B C D E], a weightings vector may be formed such that the weightings are [0.4 0.15 0.15 0.15 0.15]. Such a weighting vector may result when the decision maker provides an input to make the first prompt weigh more heavily than the other prompts. Weightings for individual evaluators may be similarly (and simultaneously) adjusted by the decision maker. User interfaces for the modification of weightings are presented in FIGS. 4A, 4B, 4C, and 4D, which are described further below.

Such weighted ratings can be mapped by the evaluation review tool 110 to the two-dimensional plot with a weighted average prompt rating as show in Equation (4), seen below:

$$\frac{{\sum }_{n = 1}^{N} {\sum }_{m = 1}^{M} {W}_{n} * Wm * {Rt}_{n , m}}{{\sum }_{n = 1}^{N} {\sum }_{m = 1}^{M} {W}_{n} * {W}_{m}} \qquad ( 4 )$$

and a weighted recommendation as seen in Equation (5) below:

Σₘ₌₁^{M}Wₘ*Rcₘ (5)

on the other axis.

As seen in Equation (4), the weights Wₙ and Wₘ are multiplied. In other embodiments, the weights Wₙ and Wₘ may be combined by the evaluation review tool 110 in other ways, such as by taking an average.

As described herein, the evaluation data may include recorded video responses of the candidates made in response to multiple prompts. Additionally, the evaluation data may include scores or ratings from other types of prompts, such as a task or an assignment. For example, a computer programming or coding exercise may be provided to each of the candidates during the evaluation. The performance of the candidate on the coding exercise may be manually or automatically generated and the performance can be represented as one or more coding scores. One or more coding scores may be scores provided by the CodeVue™ system developed by HireVue, Inc. Coding scores (or other question-based written data) may be weighted as described above.

In general, where a portion of the evaluation data has a question-based score (e.g., a multiple choice test with right answers and wrong answers), the questions may be weighted as seen in Equation (6) below: (6)

Σₙ₌₁^{N}Wₙ*metricₙ (6).

When evaluation data has an evaluator-based score (e.g., a recommendation), an evaluator-based weighting may be applied as seen in Equation (7) below:

Σₘ₌₁^{M}Wₘ*metricₘ (7).

When evaluation data is a combination of evaluator and question-based scoring (e.g., the rating of a recorded video response), weights may be combined into a weighting W_{n,m} as seen in Equation (8) below:

$$\frac{{\sum }_{n = 1}^{N} {\sum }_{m = 1}^{M} {W}_{n , m} * {metric}_{n , m} *}{{\sum }_{n = 1}^{N} {\sum }_{m = 1}^{M} {W}_{n , m}} . \qquad ( 8 )$$

In general, missing pieces of evaluation data may be left out of the calculations so that the missing data does not affect the outcome as illustrated in the two-dimensional plot. While the data weighting module 208 use the weighting data 210 and the evaluation data 212 to generate weighted performance information for a set of candidates as described above, many other algorithms, processes, and calculations may be used by the evaluation review tool 110 in other embodiments. The two-dimensional plot may be automatically updated upon entry of weightings by the decision maker, after the appropriate changes to the plot are calculated. Or in some embodiments, the user interface provided by the GUI engine 206 may provide a user interface element by which the decision maker may request that the evaluation review tool 110 update the plot.

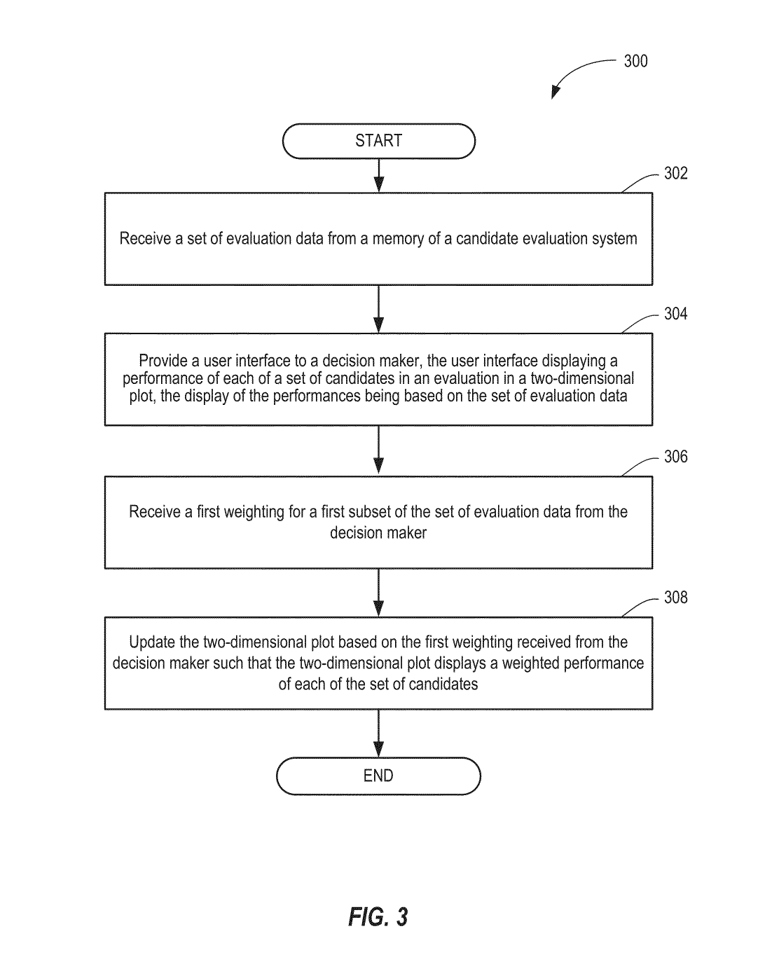

FIG. 3 is a flow chart of a method 300 of modifying using evaluation data to make a final decision according to some embodiments of the present disclosure. The method 300 may be performed by processing logic that comprises hardware (e.g., circuitry, dedicated logic, programmable logic, microcode, etc.), software (e.g., instructions run on a processing device to perform hardware simulation), or a combination thereof.

For simplicity of explanation, the method 300 may be depicted and described as a series of acts or operations. However, operations in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on a non-transitory, tangible, computer-readable medium or media to facilitate transporting and transferring such methods to computing devices.

FIG. 3 illustrates an embodiment of the method 300, which begins at block 302 in which the processing logic receives a set of evaluation data from a memory of a candidate evaluation system. For example, and a decision maker selects a particular campaign, the evaluation review tool 110 of FIGS. 1 and 2 may retrieve evaluation data, such as the ratings data 134 and the recommendation data 136 from the data store 130.

At block 304, the processing logic provides a user interface to a decision maker. The user interface may display at least a subset of the set of evaluation data. The interface may display the set of candidates in a two-dimensional plot showing the performance of each candidate of the set of candidates as indicated by the set of evaluation data. For example, the GUI engine 206 of the evaluation review tool 110 to generate instructions that are transmitted to a client 102 and rendered thereby in a two-dimensional plot. In some embodiments, the first axis of the two-dimensional plot is associated with the evaluation ratings from ratings data 134, such as Rtm described above, while the second access of the two-dimensional plot is associated with the recommendations from recommendation data 136. In other embodiments, other information such as an average of multiple coding scores may be plotted along one of the axes. The two-dimensional plot includes an indicator per candidate, which the indicator graphically showing the candidate's performance as measured along the two axes.

At block 306, the processing logic receives a first weighting or weighting value for a first subset of the set of evaluation data. For example, the evaluation review tool 110 may receive a weighting from the decision maker that emphasizes the impact of the candidates responses to a particular prompt or scores on a particular task or test. This may be done by receiving a weighting for the subset of evaluation data that corresponds to the particular prompt or task. Additionally, the evaluation review tool 110 may receive a weighting that emphasizes the impact of a particular evaluator in assessing the candidates' performance. In some embodiments, multiple weightings may be received to provide a weighing for multiple subsets in order to adjust the impact of multiple aspects of candidate performance in assessing which candidate or candidates should be selected for a position. For example, a first weighting may be for a subset associated with a particular evaluator of the set of evaluators, while a second weighting may be for a subset associated with a particular prompt of a set of prompts used in the evaluation.

At block 308, the processing logic updates the two-dimensional plot based on the first weighting received from the decision maker at block 306. The processing logic updates the two-dimensional plot based on the weighted performance of the set of candidates according to the first weighting. Where multiple weightings are received, multiple steps of updating may be performed or the weightings may be combined such that only a single step of update may be applied. Because of the updating, based on the received weighting or weightings, the evaluation review tool 110 may reposition the indicators that represent candidates on the two-dimensional plot according to how their performance as measured by the two axes of the plot is affected by the weightings. The repositioning of the indicators on the two-dimensional candidate may be done without any other action on the part of the decision maker. In some instances, the GUI engine 206 may include additional indicators on the plot to show how the weightings entered by the decision maker change the position of the indicators. Thus, two sets of indicators may be shown in some embodiments, a set of indicators at updated positions and a set of indicators at original positions. In other embodiments, a line or other market may be used to show the change in indicator position.

The method 300 may enable the decision maker to more easily visualize multiple aspects of candidates' performances and to make uniform adjustments to various subsets of the performances. The operations included in embodiments of the method 300 may be facilitated by a user interface. Examples of such a user interface are found in FIGS. 4A-D.

FIGS. 4A-D illustrate an exemplary graphical user interface 400 that may enable a decision maker to use a set of evaluation data to select among a set of candidates. Various aspects of the user interface 400 are illustrated in FIGS. 4A-D. However, the user interface 400 may be presented in many ways to enable the features described in more detail below. Many different user interface elements, such as buttons, sliders, selector elements, radio buttons, etc. may be combined in different combinations to provide the user interface 400. Some features are common to all of the illustrations of the user interface 400. Such common features have the same reference numbers in each of FIGS. 4A-D. The user interface may be generated and provided as instructions to a client device by the GUI engine 206 of FIG. 2.

The user interface 400 includes a candidate comparison window 402. In some embodiments, when a decision maker logs into or connects to the digital evaluation platform 101, the user identification module 202 of FIG. 2 identifies the decision maker. The evaluation review tool 110 may load preset or preselected weightings, such as those that may be required by a company for use by all its decision makers, and other features to customize the review of a group of candidates. In some embodiments, a particular decision maker may be identified by the user identification module 202 and be provided limited ability to adjust weightings or make other adjustments. Thus, the GUI engine 206 may customize the user interface elements in the user interface 400 according to an identity of the decision maker and according to user profiles maintained by the user identification module 202. For example, a first decision maker may be permitted by the evaluation review tool 110 to enter weightings for evaluation reviews, while a second decision maker may not. The weightings may be automatically applied when the second decision maker connects to the digital evaluation platform 101. The comparison window 402 includes an evaluation selector 404. By using the evaluation selector 404, the decision maker may select from many different evaluation campaigns to which the user identification module 202 determines the decision maker has permission to access. As illustrated in FIG. 4A, an evaluation campaign for a “JavaScript Developer II” position is selected.

The candidate comparison window 402 further includes a two-dimensional plot 410 and an evaluation review options window 420. As illustrated, the two-dimensional plot 410 graphically depicts the performance of a set of candidates as measured along two axes. Each candidate whose performance is shown in the two-dimensional plot 410 is represented by an indicator, such as indicators 412A, 412B, and 412C. The location of each of indicators 412A-C is determined by the performance of each representative candidate along a first axis 414A associated with ratings of recorded responses and along a second axis 414B, which is associated with recommendations received for each candidate. For example, the position of indicator 412A, and therefore the performance of the candidate associated with the indicator 412A, may be determined on axis 414A by the candidate's average rating and on axis 414B by the candidate's average recommendation value. In some embodiments, all of the candidates who have undergone evaluation as part of the evaluation campaign for the intended position may be included in the two-dimensional plot 410 by the GUI engine 206. In other embodiments, only a subset of these candidates that perform above a desired threshold may be shown included by the GUI engine 206. As illustrated in FIG. 4A, only the top 45% of candidates are represented by the indicators seen in the plot 410. Other threshold values may be selected by the decision maker.

The evaluation review options window 420 may provide additional information to the reviewing decision maker. As shown, the options window 420 includes a candidates tab 422, an evaluator weighting tab 440, and a score weighting tab 450. When selected, the candidates tab 422 displays a candidate list 424, which displays a list of candidates. In embodiments where a threshold is applied, only the candidates achieving higher than the threshold may be listed. The candidates tab 422 further includes average rating data 426 that has the average rating received by each corresponding candidate. In some embodiments, interface elements may be included to permit sorting or filtering candidate of the information shown in the candidates tab 422 by the decision maker. Referring

[symbol]

Referring now to FIG. 4B, when a decision maker selects a particular candidate, either by selecting the corresponding indicator in the two-dimensional plot 410 or from the candidate list 424 on the candidates tab 422, additional information particular to that candidate may be provided in the user interface 400. When the candidate, such as the candidate Martha Jones, is selected, the tooltip 416 may be provided by the GUI engine 206 in the two-dimensional plot 410 and a selection indicator 428 may highlight the candidate on the candidate list 424. As shown in FIG. 4B, the tooltip 416 provides the decision maker with data that underlies the candidates position on the two-dimensional plot 410. This “raw” data may include individual recommendations and the average ratings associated with each evaluator that reviewed the candidates' responses. For example, this raw or underlying data may be obtained by the evaluation review tool 110 from the ratings data 134 and/or the recommendation data 136 of FIG. 1. In other embodiments, the tooltip 416 includes more granular information. For example, by selecting a particular evaluator in the tooltip 416, individual ratings associated with specific prompts or specific tests or assignments may be shown to the decision maker.

As shown in the tooltip 416, one of the evaluators, Sam Hammond, appears to have given an average rating of zero to Martha Jones. This may be an indication to the decision maker that the ratings provided by Sam Hammond should not be included when assessing the performance of Martha Jones. For example, the evaluator Sam Hammond may have omitted to provide ratings for Martha Jones. In such a circumstance, the decision maker may want to limit the impact of the ratings (or lack thereof) of Sam Hammond.

Referring now to FIG. 4C, the decision maker may select the evaluator weighting tab 440, which presents multiple user interface features that enable the decision maker to adjust the impact of a particular evaluator or evaluators by adjusting weightings associated with that particular evaluator or evaluators. When the evaluator weighting tab 440 is selected, the user interface 400 may include an evaluator list 442 that lists all of the evaluators that reviewed the set of candidates represented in the plot 410. The evaluation weighting tab 440 further includes a listing or set of weights 444 corresponding to each of the evaluators present in the evaluator list 442. The set of weights 444 may be obtained from the weighting data 210 of FIG. 2.

The decision maker may limit or eliminate the impact of a particular evaluator by using a slider element 436 or a selector 438 associated with that particular evaluator. As shown in FIG. 4C, the decision maker has used either the slider element 436 or the selector 438 to eliminate the impact of Sam Hammond's assessment of candidate performance. In some embodiments, one aspect of an evaluator's assessment may be adjusted separately from other aspects of that evaluator's assessment. For example, the ratings of Sam Hammond may be weighed at 0%, while his recommendations may receive a non-zero weighting.

After the decision maker has modified the weightings, the data weighting module 208 of the evaluation review tool 110 may update the two-dimensional plot 410. In some embodiments, plot 410 may be updated continuously by the GUI engine 206 as the decision maker modifies the weightings. In other embodiments, several weightings may be received from the decision maker before the evaluation review tool 110 updates the plot 410.

Each of the weightings in weights 444 may be associated with a lock feature 439. The decision maker may select the lock feature 439 to request that the weighting be fixed at a selected level. When a lock feature is activated upon request or selection by the decision maker (shown as black in FIG. 4C) the weighting associated with the particular evaluator may not be changed by subsequently modified weightings and may limit the potential for modification of other weightings. The data weighting module 208 may receive information regarding the lock feature 439 and adjust or refrain from adjusting weightings according. For example, weightings for the ratings of Elsa Kornfeld are locked at 25%. The data weighting module 208 of the evaluation review tool 110 may prevent the decision maker from assigning a combined weighting of more than 75% to the other evaluators. The weights 444 may be used by the data weighting module 208 as the weighting vector or as a value in the weighting vector Wm, Wn, or Wn,m as described above with respect to Equations (4)-(8).

FIG. 4C also includes a third-dimension options window 443. Some embodiments of the two-dimensional plot 410 illustrate a third dimension of candidate performance by varying one or more aspects of the indicators 412A-C and other indicators. The options window 443 enables the decision maker to choose whether or not to depict a third dimension of candidate performance, how to indicate such a third dimension, and what the third dimension is to be. As shown, the options window 443 includes an indicator variation selector 444. As shown the indicator variation selector 444 enables the decision maker to request that the variation used to represent the third dimension is one of shape, size, or color. For example, as shown in FIG. 4C, “size” is selected. This is reflected in the variations in sizes of the indicators shown in the plot 410, including exemplary indicators 412A-C. The decision maker may also select what source or type of evaluation data is to be displayed in by the variation in size of the indicators. By making a selection in the data display selector 446, the decision may select one of a coding test score, a high school, undergraduate, or graduate GPA, or a number of years of experience. Many other sources of evaluation data may be selected in other embodiments. For example, the decision maker may use the data display selector 446 to display the ratings received on a specific prompt to be shown by the third dimension. As shown in in the plot 410 of FIG. 4C, the size of the indicators, including exemplary indicators 412A-C, varies according to the years of experience each candidate has, which may be obtained from the evaluation data or from a set of campaign data.

Referring now to FIG. 4D, the user interface 400 shows the evaluation review options window 420 with the input weighting tab 450 selected. When selected, the input weighting tab 450 displays multiple evaluation inputs in an evaluation input list 451. The list 451 includes many sources of evaluation data. For example, the evaluation input 452 is a writing prompt. Candidates respond to the prompt with a written response or are requested to upload a writing sample. Other evaluation inputs may include prompts that trigger recorded responses and coding tests or tasks that elicit sample code. Each of the prompts or tasks can be related to candidate responses that have been scored or rated. Thus, by using the slider element 454 of the selector element 456, the decision maker can adjust or modify the weighting associated with a particular evaluation input, resulting in a modified weighting of the associated ratings or scores. If the decision maker judges that the coding score for a task “CodeScore #2” is indicative of a good candidate, the decision maker may assign a weighting of 45% as seen in FIG. 4D. Using locks, such as exemplary lock feature 458, the decision maker may lock the weighting such that it is not decreased or increase when other weightings are modified. By limiting weightings in the input weighting tab 450 and/or the evaluator weighting tab 440 to a combined 100%, the evaluation review tool 110 may avoid the need to normalize. In other embodiments, no such limit is enforced by the evaluation review tool 110. In such cases normalization may be performed prior to computing the weighted evaluation data, as described herein.

Many variations may be presented in the user interface 400 to enable decision makers to visualize, use, and modify evaluation data set for many candidates in an evaluation campaign. While in FIGS. 4A-D, the plot 410 is illustrated as a two-dimensional in the sense that is has two axes. In some embodiments, the plot 410 is a three-dimensional plot with three-axes that may be manipulated by the decision maker to view the plot 410 from a variety of angles to review evaluation data. Other aspects of the user interface 400 may be as described herein and/or as illustrated in FIGS. 4A-D. Features described above in connection with the user interface 400 of FIGS. 4A-D may be provided by features of the evaluation review tool 110 as shown in FIGS. 1 and 2 and described herein.

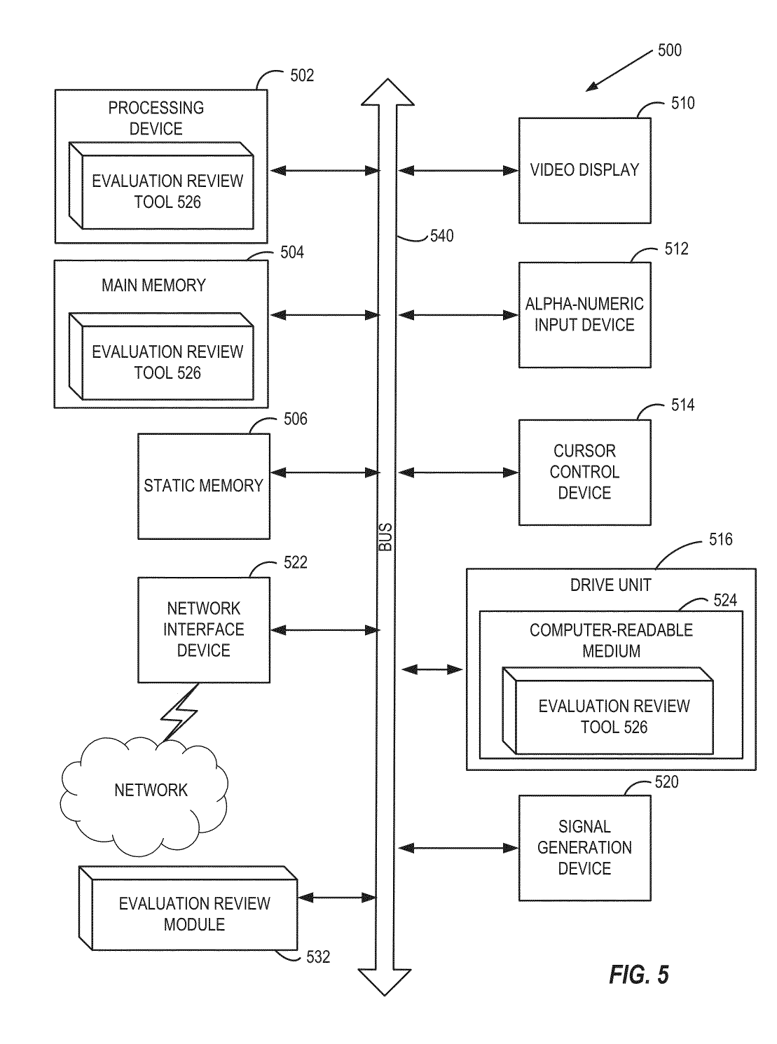

FIG. 5 illustrates a diagrammatic representation of a machine in the exemplary form of a computing system for evaluation review according to an embodiment. Within the computing system 500 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for evaluation review, including evaluation result prediction and optimized review sequence generation, for evaluating digital interviews and other assessment or evaluations, such as the method 300 as described above. In one embodiment, the computing system 500 represents various components that may be implemented in the server computing system 104 as described above. Alternatively, the server computing system 104 may include more or less components as illustrated in the computing system 500.

The exemplary computing system 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a data storage device 516, each of which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic (e.g., evaluation review tool 526) for performing the operations and steps discussed herein.

The computing system 500 may further include a network interface device 522. The computing system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a computer-readable storage medium 524 on which is stored one or more sets of instructions (e.g., evaluation review tool 526) embodying any one or more of the methodologies or functions described herein. The evaluation review tool 526 may also reside, completely or at least partially, within the main memory 504 and/or within the processing device 502 during execution thereof by the computing system 500, the main memory 504 and the processing device 502 also constituting computer-readable storage media. The evaluation review tool 526 may further be transmitted or received over a network via the network interface device 522.

While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The evaluation review tool, components, and other features described herein can be implemented as discrete hardware components or integrated in the functionality of hardware components such as ASICS, FPGAs, DSPs, or similar devices. The evaluation review module 532 may implement operations of evaluation-assessment as described herein. In addition, the evaluation review module 532 can be implemented as firmware or functional circuitry within hardware devices. Further, the evaluation review module 532 can be implemented in any combination hardware devices and software components.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “generating,” “analyzing,” “capturing,” “executing,” “defining,” “specifying,” “selecting,” “updating,” “processing,” “providing,” “computing,” “calculating,” “determining,” “displaying,” or the like, refer to the actions and processes of a computing system, or similar electronic computing systems, that manipulates and transforms data represented as physical (e.g., electronic) quantities within the computing system's registers and memories into other data similarly represented as physical quantities within the computing system memories or registers or other such information storage, transmission or display devices.

Embodiments of the present disclosure also relate to an apparatus for performing the operations herein. This apparatus may be specially constructed for the required purposes, or it may comprise a general-purpose computing system specifically programmed by a computer program stored in the computing system. Such a computer program may be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The foregoing description, for purpose of explanation, has been described with reference to specific embodiments. However, the illustrative discussions above are not intended to be exhaustive or to limit the scope of the disclosure to the precise forms disclosed. Many modifications and variations are possible in view of the above teachings. The embodiments were chosen and described in order to best explain the principles of the present disclosure and its practical applications, to thereby enable others skilled in the art to utilize the present disclosure and various embodiments with various modifications as may be suited to the particular use contemplated.

What is claimed is:

1. A method comprising:
providing, by a processing device, a user interface to a decision maker, the user interface displaying a performance of each of a set of candidates in an evaluation in a two-dimensional graphic representation, the display of the performances being based on a set of evaluation data from a candidate evaluation system;
receiving, by the processing device, a first weighting for a first subset of the set of evaluation data from the decision maker; and
updating, by the processing device, the two-dimensional graphic representation based on the first weighting received from the decision maker such that the two-dimensional graphic representation displays a weighted performance of each of the set of candidates as weighted by the first weighting.

2. The method of claim 1, further comprising:
receiving a second weighting for a second subset of the set of evaluation data from the decision maker; and
updating the two-dimensional graphic representation based on the second weighting.

3. The method of claim 2, wherein the first weighting is associated with one evaluator of a set of evaluators and the second weighting is associated with one prompt of a set of prompts.

4. The method of claim 1, further comprising:
receiving input from the decision maker selecting a candidate indicator displayed on the two-dimensional graphic representation; and
displaying underlying data associated with the candidate from the set of evaluation data.

5. The method of claim 1, further comprising fixing the first weighting at a first value upon request by the decision maker.

6. The method of claim 1, wherein the first weighting is one weighting in a set of weightings and further comprising adjusting other weightings of the set of weightings in response to receiving the first weighting from the decision maker.

7. The method of claim 1, wherein the user interface is further to receive a selection of the set of evaluation data from a plurality of sets of evaluation data, each set being associated with an evaluation campaign.

8. The method of claim 1, wherein the two-dimensional graphic representation depicts a third-dimension by a variation among indicators used in displaying each of the set of candidates, wherein the variation is variation in one of size, shape, or color.

9. The method of claim 1, wherein a first axis of the two-dimensional graphic representation is associated with evaluation ratings and a second axis of the two-dimension graphic representation is associated with evaluation recommendations.

10. A computing system comprising:
a data storage device to store a set of evaluation data, the set of evaluation data comprising evaluation ratings data and evaluation recommendation data for a set of candidates, the evaluations ratings data and evaluations recommendation data provided by a set of evaluators; and
a processing device coupled to the data storage device, wherein the processing device is to execute an evaluation review tool to:
provide a user interface to a decision maker, the user interface displaying a performance of each of a set of candidates in an two-dimensional graphic representation, the display of the performances being based on a set of evaluation data from a candidate evaluation system;
receive a first weighting for a first subset of the set of evaluation data from the decision maker; and
update the two-dimensional graphic representation based on the first weighting received from the decision maker such that the two-dimensional graphic representation displays a weighted performance of each of the set of candidates as weighted by the first weighting.

11. The computing system of claim 10, wherein the processing device is further to:
receive a second weighting of the set of evaluation data from the decision maker, the second weighting being for a second subset; and
update the two-dimensional graphic representation based on the second weighting.

12. The computing system of claim 11, wherein the first weighting is associated with one evaluator of a set of evaluators and the second weighting is associated with one prompt of a set of prompts.

13. The computing system of claim 10, wherein the processing device is further to:
receive input from the decision maker selecting a candidate indicator displayed on the two-dimensional graphic representation; and
display underlying data associated with the candidate from the set of evaluation data.

14. The computing system of claim 10, wherein the two-dimensional graphic representation depicts a third dimension by variation in indicators used in displaying each of the set of candidates, wherein the variation is variation in one of size, shape, or color.

15. The computing system of claim 10, wherein a first axis of the two-dimensional graphic representation is associated with evaluation ratings and a second axis of the two-dimension graphic representation is associated with evaluation recommendations.

16. A non-transitory computer-readable storage medium storing instructions that, when executed by a processing device, cause the processing device to perform operations comprising:
providing a user interface to a decision maker, the user interface displaying a performance of each of a set of candidates in an evaluation in a two-dimensional graphic representation, the display of the performances being based on a set of evaluation data from a candidate evaluation system;
receiving a first weighting for a first subset of the set of evaluation data from the decision maker; and
updating, by the processing device, the two-dimensional graphic representation based on the first weighting received from the decision maker, such that the two-dimensional graphic representation displays a weighted performance of each of the set of candidates as weighted by the first weighting.

17. The non-transitory computer-readable storage medium of claim 16, wherein the operations further comprise:
receiving a second weighting of the set of evaluation data from the decision maker, the second weighting being for a second subset; and
updating the two-dimensional graphic representation based on the second weighting.

18. The non-transitory computer-readable storage medium of claim 17, wherein the first weighting is associated with one evaluator of a set of evaluators and the second weighting is associated with one prompt of a set of prompts.

19. The non-transitory computer-readable storage medium of claim 16, wherein the user interface is further to receive a selection of the set of evaluation data from a plurality of sets of evaluation data, each set associated with an evaluation campaign.

20. The non-transitory computer-readable storage medium of claim 16, wherein a first axis of the two-dimensional graphic representation is associated with evaluation ratings and a second axis of the two-dimension graphic representation is associated with evaluation recommendations.
